(19) United States
(12) Patent Application Publication
(10) Pub. No.: US 2009/0110218 A1
(43) Pub. Date: Apr. 30, 2009

(54) Dynamic equalizer

(76) Inventor: Allan L. Swain, Whitmore, CA (US)

Correspondence Address: HENNEMAN & ASSOCIATES, PLC, 714 W. MICHIGAN AVE., THREE RIVERS, MI, 49093, US

(21) Appl. No.: 11/981,687

(22) Filed: Oct. 31, 2007

(51) Int. Cl. H04R 5/02

(52) U.S. Cl. 381/300

(57) ABSTRACT

A dynamic equalization system 12 for use in audio reproduction systems. The apparatus includes a chirp tone generator 38 which produces a tone having multiple frequencies. The chirp tone is broadcast into the listening space 10 from a transducer 14. The broadcast chirp tone is monitored by a second transducer 22 at the listening position to produce a received chirp tone. The received tone and the original tone are compared in a coefficient computer 44 connected to a programmable equalizer 42. The equalizer 42 uses the signal from the coefficient computer to compensate for irregularities 47 in listening space 10 and transducer 14 to produce a substantially undistorted listening experience from source 28 in listening space 10. The first step of the method of the invention is generation of a chirp tone. The chirp tone includes multiple frequencies. The chirp tone is broadcast into the listening space from a transducer placed at the selected transducer position. The broadcast chirp tone is next monitored by a transducer at the listening position to produce a received chirp tone. The received tone is then compared to the generated chirp tone and differences noted. The differences are used to program an equalizer for correction of sound. The process is done for each position where a transducer is located. Finally, sound from a program source is routed through the equalizer to the transducers for a corrected sound.

### BACKGROUND OF THE INVENTION

1. Field of Invention

This invention relates generally to audio reproduction systems such as those used in home theater systems, and particularly to systems and method for equalizing the sound source apparatus.

2. Description of the Prior Art

A home theater audio system generally includes a source of an audio signal such as a DVD player. This signal is amplified and distributed to a plurality of audio reproduction devices such as speakers or headphones. A purpose of such systems is to provide high fidelity sound reproduction according to the traditional criteria of frequency response, dynamic range, and freedom from distortion. An additional purpose of such systems is to provide spatial acoustic realism. Spatial realism is defined as a perceived spatial distribution of sound that is in accordance with visual and other cognitive expectations commonly associated with the sounds. Electrical to acoustic transducers such as speakers and headphones have physical limitations that can significantly affect the performance of an audio system. One method of avoiding this limitation is by compensating the frequency envelope of the sound. This process is also called equalization. This is often done by interposing a series of band pass filters, either active or passive, along the path between the source and the audio reproduction device.

Several systems providing various degrees of spatial acoustic realism, also referred to as surround-sound, are known in the art and described for example in Greenberger U.S. Pat. No. 5,708,719, and these require the use of 3 to 6 speakers.

Automated systems for setting speaker levels have also been produced where an amplifier produces a test tone during setup which is detected by a microphone placed at the listeners' position. The signal is used to adjust speaker levels and compensate for irregularly placed speakers. Such systems do not typically provide frequency equalization nor do they account for differences in phasing produced by speaker placement.

Equalization of individual speakers is also often predetermined at the factory and included by means of a circuit module in or attached to the speaker system. Alternatively, the equalization is made during installation as a user adjustment of an equalizer circuit that is part of the audio reproduction system.

Speaker equalization alone is not adequate for high end systems; there is a need also to compensate for the frequency response artifacts introduced by the home theater room and its contents, depending on the disposition of the speakers. Speaker placement also affects the relative phase of sound components arriving at the listener in ways that cannot be compensated by amplitude adjustments alone, and which require accurately determinating the individual speaker locations. Further, manual equalization during installation is highly inconvenient and difficult for the average home theater user, and expensive if required to be done by a trained technician, owing to the considerable number of speakers. Consequently, there is need for an improved equalizer system for home theater use that will overcome these shortcomings.

### SUMMARY OF INVENTION

This invention provides an improved dynamic equalizer system to equalize the frequency response of a speaker and room combination automatically, as a system configuration menu item available through a user interface, by computing the response of a microphone to a test signal generated by firmware in the system. It is provided in one embodiment as part of a versatile audio distribution module (ADM) that can supply outgoing signals to a multiplicity of speakers (audio transducers), from incoming audio source signals.

The dynamic equalizer system of this invention measures and sets equalization parameters for the acoustic responses of home theater speakers in their actual application environment. It is in one embodiment a user-initiated automated subsystem of an audio distribution module (ADM). It is intended to be used during a new installation and when changes have occurred in the acoustic environment of a home theater listening space. The equalization parameters for a multiplicity of speakers, for example 2 to 8 in number for a typical home theater audio system, can be determined and set, one at a time by the dynamic equalizer system, in the ADM, in the same manner as will be described in further detail hereinbelow for one particular speaker. Alternatively, the inventive dynamic equalizer system can be provided in other convenient forms, for example, as a separate audio component connected into the signal path of a component audio system, or as a handheld unit; which can be the size of a cell phone, or even distributed throughout a digital audio delivery system.

The first step of the method of the invention is generation of a chirp tone. The chirp tone includes multiple frequencies. The chirp tone is broadcast into the listening space from a broadcast transducer placed at the intended position. The broadcast chirp tone is monitored by a second transducer sited at the position a listener would sit. The output of the second transducer may be digitized resulting in a digitized received chirp tone. The received chirp tone is then compared to the generated chirp tone and amplitude differences noted. The differences are used to program an amplitude equalizer to correct the sound received at the second transducer. The process is done for each position where a broadcast transducer is located. This process may be performed either simultaneously or serially.

Simultaneous with the detection of the chirp tone received by the second transducer, similar transducers located near each of the other speakers that are not broadcasting the chirp tone, detect the chirp tone and record its arrival time. On completion of the amplitude equalization process the arrival time information stored in each of the speakers for each transmitted chirp are used to compute a map of precise speaker placement relative to the listening position and to each other. This geometry information is then used to further program a delay equalizer to compensate for phase variations due to speaker placement. The steps of amplitude equalization and phase equalization are separable and may be performed in any sequence. Finally, sound from a program source is routed through the equalizers to the broadcast transducers for a corrected sound.

### BRIEF DESCRIPTION OF THE FIGURES

In the accompanying drawings:

FIG. 1 is a plan representation of a first embodiment of the invention, disposed in a home theater;

FIG. 2 is a block diagram of the apparatus of a first embodiment of the invention;

FIG. 3 is a representation of the waveform of the chirp sound;

FIG. 4 is a graph of the time variation of the chirp frequency;

FIG. 5 is a table showing equalizer bands;

FIG. 6 is a representation of the first portion of a received digital chirp signal; and

FIG. 7 is a diagram of the method of the invention.

### DETAILED DESCRIPTION

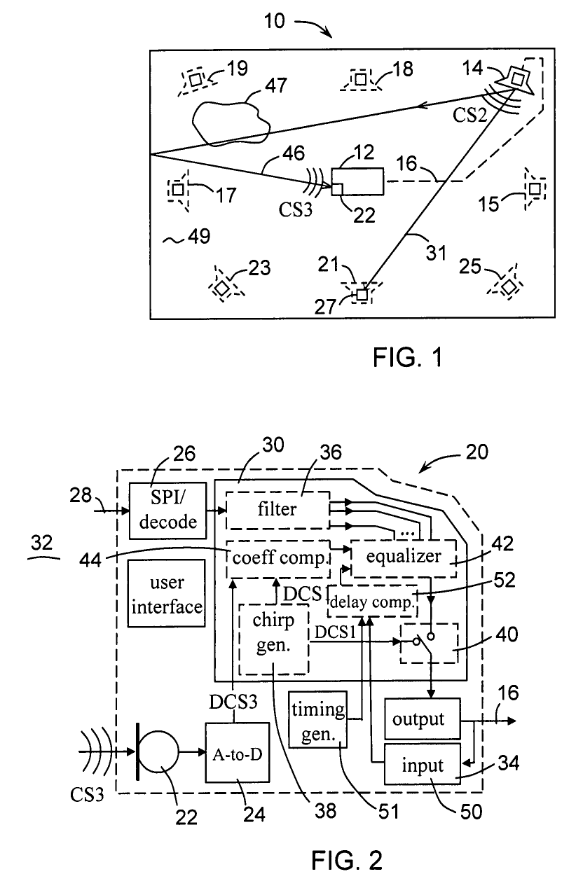

FIG. 1 shows a home theater room 10 with audio distribution module (ADM) 12 in a standard listening and viewing position near the center of the room. ADM 12 is connected to a sound generating transducer 14. Transducer 14 may be an electromagnetic or electrostatic speaker. The connection between ADM 12 and transducer 14 may be by a wire connection 16. It is also within the concept of the invention that transducer 14 be connected to ADM 12 by a wireless connection. It is also within the concept of the invention that the connection 16 between ADM 12 and transducer 14 may be bidirectional. Transducer 14 may be separately powered in some configurations and has appropriate attached circuits to accommodate a digital input signal from wire 16. In another embodiment, transducer 14 may be connected to ADM 12 with a direct analog audio drive over wire 16 without need of a separate power source. Transducer 14 is shown disposed in the conventional Right Front location. In a typical home theater arrangement, ADM 12 is also connected to a plurality of transducers disposed in six conventional home theater speaker locations, such as Right Front 14, Left Front 19, Center Front 18, Right Surround 15, Left Surround 17, and Subwoofer 21 locations. Note each speaker as described herein may include multiple transducers for producing sound and at least one transducer for detecting sound. Subwoofer location 21 is arbitrary in many applications; however, alternative embodiments are capable of having multiple subwoofers, including subwoofers at positions 14, 15, 17, and 19. A system as described is referred to as a 5.1 system. Systems commonly also have one or two rear speakers 23 and 25 and are referred to as 6.1 or 7.1 systems respectively. There are also 2.0 systems called conventional stereo, 2.1 stereo with a subwoofer, and 3.1 systems stereo with an additional center front speaker 18 and a subwoofer 21. Many systems are capable of operating in multiple modes, dependant upon program material and personal preference. In addition, multiple program modes influence the phasing of individual transducers and are useful for special effects. As can readily be appreciated manually setting the levels, phasing, and equalization of this many transducers is a daunting portion of installation.

FIG. 2 is a block diagram of the apparatus of a first embodiment of the invention. In particular, a portion 20 of ADM 12 is illustrated. In an actual system as contemplated, portion 20 may be duplicated for each channel. Alternatively, a single portion 20 may be switched between channels for sequential operation. Portion 20 includes several functional subsystems identified by the blocks shown. For convenience, this operation will be explained for a single speaker 14, but it will be apparent that the invention contemplates multiple speakers and operation modes.

A sound receiving transducer 22 such as a microphone at the listening position receptive to the room environment is connected to the input of an analog-to-digital (A-to-D) converter 24. In one embodiment A-to-D converter 24 is operating at a 48 KHz sampling rate as used in digital TV and DVD audio. A-to-D converter 24 produces a digital signal from the analog signal received from microphone 22 at its output connected to an input of Digital signal processor (DSP) 30. For convenience, we will refer to this signal as digital chirp signal (DCS3). The dynamic response characteristics of microphone 22 are chosen to exceed the characteristics of the human ear, and this is readily and economically available in current art, which provides substantially distortion-free conversion from acoustic to digital signals.

A serial interface (S/PDIF) 26 with digital audio input line 28 is also connected to another input of a DSP 30. A user interface 32 such as a keyboard and LCD display connected to DSP 30 allows a user to control operation of the device. An output circuit 34 connected to the output of DSP 30 provides digital audio output through connection 16 to separately powered speaker 14 which is also equipped with its own sound receiving transducer 27 such as a microphone. An input circuit 50 receives digital information from a multiplicity of such receiving transducers 27 through connection 16 and provides another input to DSP 30.

DSP 30 includes several subsystems which are shown as dashed blocks in FIG. 2. DSP 30 can be constructed from a multiprocessor. This requires processing of multiple frequency bands and complex calculations which may include Fourier transformations. Due to the high processing demands, a processor which includes a multiplicity of processor cores and random access (RAM) and read only (ROM) memory configured to operate as the dynamic equalizer system of the invention is often used. A multi core processor such as the SEAforth™ processor manufactured by IntellaSys™ of Cupertino, Calif. is particularly suited for this application. A filter 36 is connected to the output of S/PDIF 26. Filter 36 may be a digital filter. A chirp signal generator 38 is connected to equalizer coefficient computation subsystem 44, and to output 34 dependant upon the position of a signal selector switch 40. Chirp signal generator 38 generates a signal DCS1 which may be digital or analog. An equalizer 42 receives the outputs of filter 36, equalizer coefficient computation subsystem 44, and equalizer delay computation subsystem 52. Delay equalizer computation subsystem 52 receives timing information from timing generator 51 and remote timing information from input circuit 50. Equalizer 42, which can be a 12-band equalizer, outputs to output 34 if signal selector switch is changed to its output position. Subsystems 36, 38, 40, 42, 44, 51, and 52 of processor 30, and elements of subsystems 34 and 50 may be included as firmware in ROM elements of processor 30. Another embodiment of the invention uses custom silicon circuits. Yet another embodiment of the invention uses discrete components or a combination of said elements, circuits, and components. The system can also be embodied in software in an external processor communicating with ADM 12 over a wireless connection.

Dynamic equalization is initiated by making an appropriate selection (command) on user interface 32, such as a menu on user interface 32. Selection choices may include choice of a particular speaker or a set of speakers, or a particular sequence of speakers, and choice of chirp signal parameters, according to the application; alternatively, the selection can be simply a user command to start an automatic, fully predetermined, user-friendly dynamic equalization process, appropriate to the application. In response to a start command, chirp generator 38 generates chirp signal DCS1 which may be a digital audio chirp signal in the format of the 48 KHz standard sampling rate. It will be useful to define also a chirp sound CS1 (not actually generated by the system) to which DCS1 corresponds.

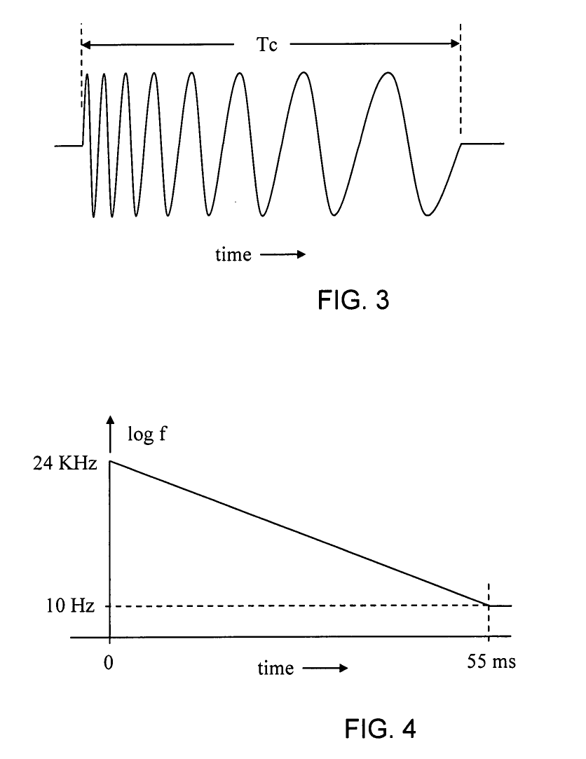

FIGS. 3 and 4 illustrate the chirp signal and the corresponding chirp sound CS1 according to the invention. FIG. 3 is a representation of the instantaneous sound pressure graph of CS1, and FIG. 4 depicts its frequency variation in greater detail. The chirp is shown to be a pulse of time duration Tc with constant peak-to-peak amplitude and continuously varying frequency, producing in effect a frequency sweep; the time duration Tc is 55 milliseconds in this embodiment, with the frequency decreasing linearly from 24 KHz to 10 Hz. Alternatively, the chirp can have step-wise variation of frequency comprising a sequence of steady single tones and still alternatively, steady multiple tones, and further alternatively, other convenient time variation of frequency can be employed for the chirp, with said variation of frequency spanning any pertinent band of interest. Tc time duration of 55 milliseconds is chosen to correspond roughly to an average single reflection sound transmission time from speaker 14, disposed about 1 meter from the corner of the room, to ADM 12 disposed in a listening space near the center of a home theater room with a diagonal dimension of 15 meters; alternatively, other chirp signal parameters may be employed, according to the application. Tc may be automatically selected by the invention or set by the user.

Returning to FIGS. 1 and 2, when the calibration mode is activated chirp signal DCS1 is connected via selector 40 to output circuit 34, in place of a digital audio signal which would come from input line 28 of the ADM 12 in play mode. DCS1 is further transmitted through wire connection 16 to transducer 14. Alternatively, a wireless signal connection as noted hereinabove can be substituted for wire connection 16. DCS1 is converted into an emitted acoustic chirp signal (chirp sound) CS2 by transducer 14. CS2 can be noticeably different from CS1 due to physical limitations of current art speakers. CS2 is transmitted through room 10 and received as CS3 at the listening space and ADM 12, and at the adjacent transducer 17 and its microphone 27. The path is not necessarily direct, and various paths such as, for example, path 46 involve diffraction around a potted plant 47 and reflection off wall 49 opposite transducer 14. Paths that sound can take include each of the following alone or in combination: direct transmission, diffraction around other objects, absorption, other reflections, and reemission from compliant structures in the room. The nature of the sound received at microphone 22 is dependant upon the fabrics used for the furniture, the curtains and floor covering, and the placement of transducer 14 with respect to reflecting surfaces in the room. Each of these factors can cause distortions of the sound so that the chirp sound CS3 received at the listening space and ADM 12 is noticeably different from the emitted chirp sound CS2 adjacent the speaker. These distortions can be represented as changes in the relative magnitude of the Fourier coefficients (amplitudes) of the sound, and can be compensated (equalized) by modifying said coefficients (i.e., the frequency envelope) of the sound. For example, a speaker resonance at 120 Hz will appear as an amplitude peak at 120 Hz, relative to the amplitude of the rest of CS3. Similarly, a loss of high frequencies owing to selective absorption in room carpets and upholstery will appear as reduced amplitude in the affected frequency range of CS3. Accordingly, the amplitude of received chirp sound CS3 will vary over the chirp duration (equivalent to a frequency sweep), owing to the distortions produced by the speaker and the room transmission.

The sound incident on microphone 22 provides a sample of the received chirp sound CS3 in the listening space. This sample is converted to an analogue electrical signal. This analog signal is in turn converted into digital by A-to-D converter 24, resulting in received digital chirp signal DCS3. DCS3 is conveyed to equalizer coefficient computation subsystem 44, in processor 30. DCS1 is also provided to equalizer coefficient computation subsystem 44 as it is generated by chirp generator 38. If there were no speaker or room distortions, the received chirp sound produced from chirp signal DCS1 would be CS1 (i.e., CS3 would be equal to CS1). Accordingly, the multiplicative coefficient needed to compensate for the effect of combined speaker and room distortions (i.e., the equalizer coefficient) at a particular frequency is the Fourier amplitude ratio of DCS1 to DCS3 at that frequency. Further, as the peak-to-peak amplitude of the audio frequency variation of DCS1 is constant with time (and frequency) over the chirp duration Tc, and therefore also the Fourier amplitude is substantially constant with frequency, the equalizer coefficient is simply 1 divided by the Fourier amplitude of DCS3, within a constant scale factor.

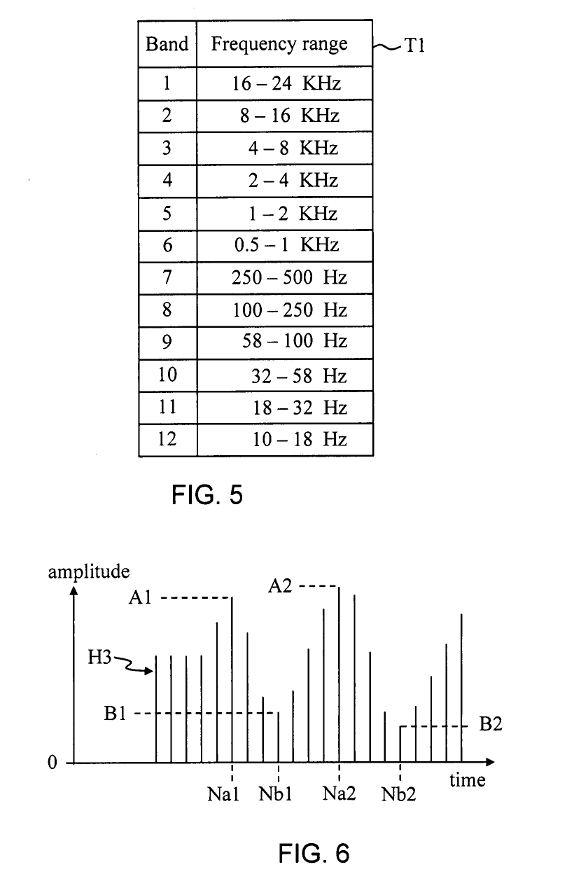

The audio frequency range is divided into several frequency bands and the audio signal level in each frequency band is multiplicatively adjusted in real time by an average equalizer coefficient for that band. According to the present invention, a digital audio signal on input line 28 of the ADM is connected through the S/PDIF and decoder 26 to processor 30 and therein analyzed (separated) in filter 36, into a multiplicity of frequency bands spanning the frequency range of 24 KHz to 10 Hz. As an example, 12 bands are specified in table T1, in FIG. 5. The signal amplitude in each band will then be multiplied by the respective equalizer coefficient and the signals recombined, in equalizer 42. The resulting corrected signal is connected via signal selector switch 40 to output circuit 34, line 16, and a speaker, for reproduction of the sound without distortion.

As the frequency-time variation of the chirp is known, the Fourier amplitude ratios and hence the equalizer coefficients can be computed in the time domain, without using filters. According to a first method of computation of the equalizer coefficients, the received digital chirp signal DCS3 is stored as an array H3 of (instantaneous) amplitude samples in non-volatile memory, by processor subsystem 30. DCS3 is in general delayed with respect to DCS1 by an unknown time displacement, and thus the time (and frequency) correspondence is found by computing the convolution (multiplication and summation) of H3 with the generated amplitude samples H1 of DCS1, in the time domain, for different time displacements of H3 with respect to H1, and finding the maximum correlation (maximum convolution value) as a function of time displacement. The convolution of H3 with H1 is performed in a particular way, by first computing the partial sums within time subintervals of the chirp that corresponds in frequency to the equalizer frequency bands, and then summing over the entire chirp duration Tc. Once the maximum correlation is found, the last computed partial sums Mj, where j is an index referring to a particular band, can be directly used to compute the average equalizer coefficients for the bands.

At a constant sampling rate, for example 48 KHz, and for equalizer bands that correspond to about equal subintervals of chirp duration Tc as shown in FIGS. 4 and 5, and with a constant amplitude chirp signal as shown in FIG. 3, the convolution of H1 with itself will generate partial sums Lj that are equal for all bands (constant with respect to j). It will be further apparent that owing to the distributive property of convolution, Lj/Mj expresses the average Fourier amplitude ratio of DCS1 to DCS3 in band j, and still further, as Lj is constant, the equalizer coefficient CJ for band j (as given for example in the Band column of table T1 in FIG. 5) can be computed within a scale factor common to all bands, according to a first formula:

Cj=1/Mj.

It should be noted that the amplitudes of audio signals are commonly specified on a logarithmic scale referenced to a standard amplitude, and accordingly, the equalizer subsystem 42 can be adapted to employ the mathematical operations of addition and subtraction (instead of multiplication by Cj or division by Mj) to apply the equalization coefficients to an audio signal in play mode as described hereinabove.

There is a second alternate method of computation in which the Fourier amplitudes are approximated by peak-to-peak values of audio-frequency amplitude variations in time. In particular, the array H3 of amplitude samples is processed to extract a running sequence of maximum and minimum values A1, A2, . . . Ak, . . . and B1, B2, . . . Bk, . . . respectively, and their corresponding sample indices Nak and Nbk (running sample counts N at which the k-th maximum and minimum is found) as shown in FIG. 6. The index k refers to the sequential position of an amplitude maximum (and minimum), starting with k=1 for the first observed maximum (and minimum). The equalizer coefficient Ck at frequency fk=48,000/(2*(Nbk−Nak), wherein the frequency units are Hertz and the constant 48,000 is the sampling rate, can be computed, within a scale factor common to all Ck, according to the following second formula:

Ck=1/(Ak−Bk).

It may be advantageous not to store the entire set of amplitude samples for a chirp, but only the maxima, minima, and their corresponding sample counts, or alternatively, the values of Ck and fk as they are received and computed, thereby saving memory space. In order to compute an equalizer coefficient appropriate for a band, for example, one of the bands specified in table T1 in FIG. 5, all Ck values at frequencies fk within the band can be averaged. Alternatively, according to the nature of the speaker and room distortions that may be operative in an application, the fk values can first be processed to select only one frequency for each band, which corresponds most closely to a predetermined representative frequency within the band, such as the geometric mean of the band edges, and the Ck value can then be computed for each band at that one frequency, thereby saving computation time and more memory space. Still alternatively, those familiar with the art will appreciate that the representative frequency within the band can be selected to correspond to a sharp resonance peak or absorption notch that may be found by said processing of the fk values, and it is anticipated that this capability will be especially useful in applications involving sound recording in addition to sound reproduction, to suppress resonances and boost up tonal holes. Further alternatively, the choice of using averaged equalizer coefficients or those evaluated at predetermined frequencies can be given as a user selectable menu item of the ADM.

The chirp sound generated by transducer 14 is also incident on transducer 27 at transducer 17 and provides an analogue sample of the broadcast chirp sound which is also converted to a similar digital signal DCS3 by a similar A-to-D converter 24 and computational system 30 co-located with transducer 17. Transducer 17 is similarly connected to ADM 12 through a wired or wireless connection and receives the same chirp signal as transducer 14 but is muted to suppress any sound from being produced. The computational system 30 at transducer 17 then compares the initial timing relationship between the DCS1 signal received from ADM 12 and the chirp sound detected by transducer 27 and computes and stores the difference as the delay of the direct sound path 31. This distance information is in turn used to compute the relative transducer placement in the room with respect to the listening position and each transducer and to correct for variations in room geometry by equalizing the relative delay through each transducer path to correct the relative phase of the sound from each transducer at the listener.

It is appreciated that the initial recording of multi-channel sound information makes several assumptions about the characteristics of the listening environment that are ultimately beyond the control of the recording studio. The first assumption is that users will position their array of transducers in the optimum locations for best listening and advisories to this effect are published to encourage these configurations. Several conflicting requirements in the home, from decor choices to furniture and listeners preferences, make any optimization more difficult. The ability to detect and analyze sounds from multiple sources in rapid succession and compute corrective parameters that adjust both the amplitude and phase of sound to compensate for the variations produced by moving transducers, or furniture, or listening positions and to automate this process results in an overall improvement in the listening experience.

The dynamic equalizer system of the invention in some embodiments is combined in the ADM with several other multiplicative adjustments of the audio signal level in the equalizer bands, comprising, first, fixed factory equalization coefficients for the speakers based upon the design of the speaker, for example, ported or non-ported, that can provide the default equalization with normalized delay when the dynamic equalizer system is not applied; second, any equalization settings that the user may specify according to how he wishes the music to be affected for his own personal use; and third, a loudness level or master gain control incorporating the standard frequency response curves of the human ear at different loudness levels.

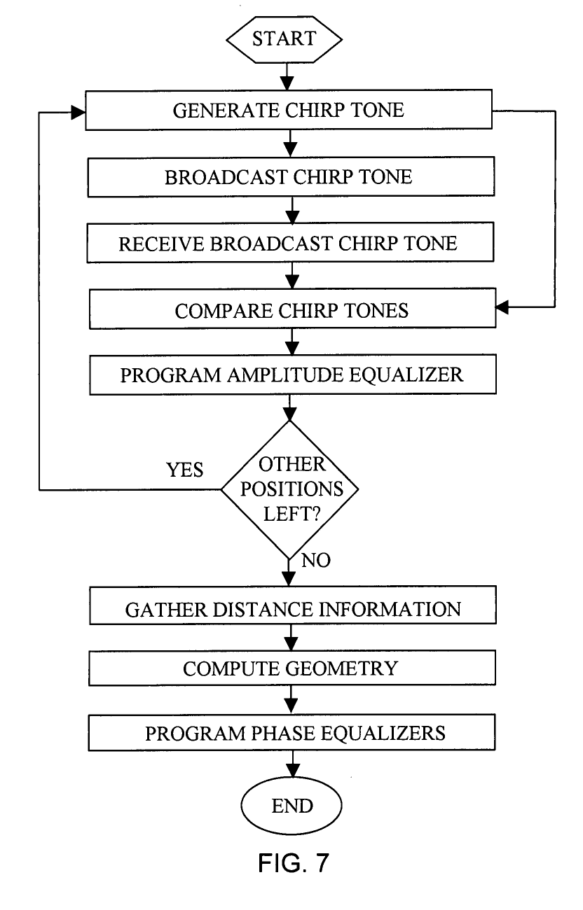

FIG. 7 is a diagram summarizing the method of the invention. The first step is generation of a chirp tone. The chirp tone includes multiple frequencies, and several examples of chirp tones are illustrated above. The multiple frequencies may be accomplished by either a constant amplitude wave form of changing frequency or a complex waveform resolvable into multiple frequencies. The chirp tone is broadcast into the listening space from a selected transducer placed at the position selected by the user. The broadcast chirp tone is monitored by a second transducer at the users' listening position. The output of this second transducer is the received chirp tone. The received chirp tone may be digitized, resulting in a digitized received chirp tone. The digitized received chirp tone is compared to the generated chirp tone and differences in amplitude and phase are noted. The differences are used to program an equalizer for correction of sound. The process is done for each position where a broadcast transducer is located. This process may be performed either simultaneously or serially. Finally, a sound signal from a program source is routed through the equalizer and the broadcast transducers to produce a corrected sound.

The foregoing description of embodiments of the present invention has been provided for the purposes of illustration and description. It is not intended to be exhaustive or to limit the invention to the precise forms disclosed. In the interest of clarity about the invention, the illustrations and textual description of the embodiments described herein contain a number of simplifications and omissions that will be recognized by those skilled in the art. Many modifications and variations will be apparent to those skilled in the art. These variations are intended to be included in aspects of the invention. In addition, various features and aspects of the above described invention may be used individually or in combination. The embodiments described herein were utilized to explain the principles of the invention and its application, thereby enabling others skilled in the art to understand the invention for various embodiments and with various modifications as are suited to the particular use contemplated.

### INDUSTRIAL APPLICABILITY

The inventive ADM 12, subsystems 30, generators 38, filters 36, equalizers 42, and method of FIG. 7 are intended to be widely used in a great variety of audio applications. It is expected that they will be particularly useful in applications where significant computing power is required due to the large numbers of channels and broad frequency range, and yet power consumption and heat production are important considerations.

As discussed previously herein, the applicability of the present invention is such that the equalization of audio components is greatly enhanced, both in speed and versatility. Also, accurate reproduction of sound is enhanced using relatively inexpensive components according to the described method and means.

Since the ADM 12, subsystems 30, generators 38, filters 36, equalizers 42, and associated apparatus and method of FIG. 7 of the present invention may be readily produced and integrated with existing tasks, input/output devices and the like, and since the advantages as described herein are provided, it is expected that they will be readily accepted in the industry. For these and other reasons, it is expected that the utility and industrial applicability of the invention will be both significant in scope and long lasting in duration.

I claim:

1. A method for equalization of sound in accordance with room and transducer characteristics from a source in a listening environment having multiple sound producing transducers, at least one sound detection transducer, and a listening position, comprising the steps of generating a chirp tone which includes multiple frequencies, and broadcasting the chirp tone into the listening environment from at least one transducer, and monitoring the broadcast chirp tone at the sound detection transducer and at the listening position,for producing a received chirp tone, comparing said received chirp tone to said chirp tone to determine amplitude and timing differences, programming an equalizer with said differences to equalize a signal passed through the equalizer in accordance with room and transducer characteristics, and directing the signal from said source through said programmed equalizer to said transducer.

2. A method for equalization of sound in accordance with room and transducer characteristics from a source in a listening environment having multiple sound producing transducers and a listening position as in claim 1, wherein there are multiple sound detection transducers and said method is performed for each position a transducer is located.

3. A method for equalization of sound in accordance with room and transducer characteristics from a source in a listening environment having multiple sound producing transducers and multiple sound detection transducers a listening position as in claim 2, wherein said method is performed for each position a transducer is located simultaneously.

4. A dynamic equalizer for use in audio systems in a listening environment and transducers comprising; a chirp tone generator for producing a tone including multiple frequencies, an output for propagating chirp tones generated by said chirp tone generator into the listening environment, and a coefficient computer having at least two inputs with one input connected to said chirp tone generator and one input connected to the listening environment for programming a programmable equalizer, and a programmable equalizer connected to said coefficient computer for equalizing audio signals in accordance with the listening environment and transducer.

5. A dynamic equalizer as in claim 4, wherein equalizer coefficients are computed in the time domain, without using filters.

6. A dynamic equalizer as in claim 4, further comprising an output with its output connectable to a transducer and a switch for selectively connecting its input to said chirp tone generator and said programmable equalizer.

7. A dynamic equalizer as in claim 4, wherein one connection to the listening environment to said coefficient generator is an analog to digital converter and a microphone.

8. A dynamic equalizer as in claim 4, further comprising an additional sound detection transducer located near at least one sound reproduction transducer.

9. A dynamic equalizer as in claim 8, further comprising a serial interface connectable to an audio source connected to said additional sound detection transducer.

10. A dynamic equalizer as in claim 9, further comprising an output with its output connectable to a transducer and a switch for selectively connecting its input to said chirp tone generator and said programmable equalizer.

11. A dynamic equalizer as in claim 10, wherein one connection to the listening environment to said coefficient generator is an analog to digital converter and a microphone.

12. An audio reproduction system connectable to a source of audio information for reproducing sound in a listening environment comprising a plurality of sound producing transducers for converting electrical energy into sound, and an amplifier connected to said transducers for increasing the strength of the signal from said source, and a dynamic equalizer connected between said source and said amplifier comprising; a chirp tone generator for producing a tone including multiple frequencies, an output for propagating chirp tones generated by said chirp tone generator into the listening environment, and a coefficient computer having at least two inputs with one input connected to said chirp tone generator and one input connected to the listening environment for programming a programmable equalizer, and a programmable equalizer connected to said coefficient computer for equalizing audio signals in accordance with the listening environment and transducer.

13. An audio reproduction system as in claim 12, further comprising a user interface connected to said chirp tone generator.

14. An audio reproduction system as in claim 12, further comprising an output with its output connected to said amplifier to at least one of said transducers and a switch for selectively connecting its input to said chirp tone generator and said programmable equalizer.

15. An audio reproduction system as in claim 12, wherein one connection to the listening environment to said coefficient generator is an analog to digital converter and a microphone.

16. An audio reproduction system as in claim 12, further comprising a filter connected to said programmable equalizer.

17. An audio reproduction system as in claim 16, further comprising a serial interface connectable to an audio source connected to said filter.

18. An audio reproduction system as in claim 17, further comprising an output with its output connectable to said amplifier and a switch for selectively connecting its input to said chirp tone generator and said programmable equalizer.

19. An audio reproduction system as in claim 12, wherein one connection to the listening environment to said coefficient generator is an analog to digital converter and a microphone.

20. An audio reproduction system as in claim 12, wherein each of said transducers is selected separately for equalization.

21. An audio reproduction system as in claim 20, wherein all transducers are equalized substantially simultaneously.
